(19) United States
(12) Patent Application Publication
(10) Pub. No.: US 2026/0061740 A1
(43) Pub. Date: Mar. 5, 2026

(54) CYLINDER ROLL AIR ROUTING FOR DECORATOR PLATE

(71) Applicant: Stolle Machinery Company, LLC, Centennial, CO (US)

(72) Inventors: Ian Kenneth Scholey, Barnsley (GB); Bryon Lee Kajfosz, Littleton, CO (US); Stephen Dane Christensen, Highlands Ranch, CO (US)

(73) Assignee: Stolle Machinery Company, LLC, Centennial, CO (US)

(21) Appl. No.: 19/314,495

(22) Filed: Aug. 29, 2025

Related U.S. Application Data
(60) Provisional application No. 63/689,136, filed on Aug. 30, 2024.

(51) Int. Cl. B41F 27/00; B41F 13/11; B41F 17/22; B41F 33/00

(52) U.S. Cl. CPC B41F 27/00; B41F 13/11; B41F 17/22; B41F 33/00

(57) ABSTRACT

An arrangement for communicating a supply of pressurized gas to a plate cylinder of a decorator machine includes a rotatable shaft disposed within the decorator machine; and a number of passageways defined in the rotatable shaft. Each passageway of the number of passageways having an inlet structured to receive the supply of pressurized gas and an outlet structured to convey the supply of pressurized gas to the plate cylinder.

### CROSS REFERENCE TO RELATED APPLICATIONS

This application claims priority to U.S. Patent Application Ser. No. 63/689,136, filed Aug. 30, 2024, titled “CYLINDER ROLL AIR ROUTING FOR DECORATOR PLATE”.

### FIELD OF THE INVENTION

The disclosed concept relates generally to can decorator machines for use in decorating can bodies, and more particularly to air routing arrangements utilized in such machines. The disclosed concept further relates to decorator shaft arrangements for use in can decorator machines.

### BACKGROUND OF THE INVENTION

A purpose of the disclosed concept is to provide a means of supplying air to the plate cylinder/applicator roll/gravure roll of a can decorator machine to actuate a sleeve so that the actuated sleeve may be easily removed from the machine. Previous attempts by manufacturers, such as Sandon Global, have not incorporated air supply into machine components themselves, but instead have relied on an external source of air supply that connects a hose to the cylinder/roll. This external supply source must be manually connected to the cylinder/roll and requires that the hose be disconnected from the machine before restarting the machine. It also generally requires the operator to carry around a compressed air bubble to provide pressurized air to the cylinder which can be a safety hazard due to the weight of the compressed air bubble and the environment that the compressed air bubble must be carried through. Hence, there exists a need for improved arrangements for supplying air to the plate cylinder/applicator roll/gravure roll of a can decorator to actuate a sleeve thereof so that the actuated sleeve may be easily removed from the machine.

### SUMMARY OF THE INVENTION

As one aspect of the disclosed concept, an arrangement for communicating a supply of pressurized gas to a plate cylinder of a decorator machine is provided. The arrangement comprises: a rotatable shaft structured to be disposed and rotated within the decorator machine; and a number of passageways defined in the rotatable shaft, each passageway of the number of passageways having an inlet structured to receive the supply of pressurized gas and an outlet structured to convey the supply of pressurized gas to the plate cylinder.

The arrangement may further comprise a valve in communication with the number of passageways and structured to selectively control the supply of pressurized gas to the plate cylinder. The valve may be disposed and configured to selectively control the supply of pressurized gas to the plate cylinder by selectively controlling the supply of pressurized gas to the number of passageways. The valve may be disposed and configured to selectively control the supply of pressurized gas to the plate cylinder by selectively controlling the supply of pressurized gas from the number of passageways to the plate cylinder. The valve may comprise a manual valve. The valve may comprise a solenoid valve. The arrangement may further comprise a controller in communication with the solenoid valve, the controller being structured to selectively control operation of the solenoid valve. The arrangement may further comprise: a number of sensors, each sensor of the number of sensors being structured to detect a pressure and/or a flow of the supply of pressurized gas to the plate cylinder; and a controller in communication with the number of sensors, the controller structured to control operation of the decorator machine based on the pressure and/or the flow detected by the number of sensors. The arrangement may further comprise a pressurized air source structured to produce the supply of pressurized gas. The pressurized air source may comprise an air compressor.

As another aspect of the disclosed concept, a decorator machine is provided. The decorator machine comprises: a plate cylinder; and an arrangement for communicating a supply of pressurized gas to the plate cylinder such as described above.

These and other objects, features, and characteristics of the disclosed concept, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are provided for the purpose of illustration and description only and are not intended as a definition of the limits of the disclosed concept.

### BRIEF DESCRIPTION OF THE DRAWINGS

A full understanding of the disclosed concept can be gained from the following description of the preferred embodiments when read in conjunction with the accompanying drawings in which:

FIG. 1 is a partially schematic partially sectional view of a can decorator machine having an example actuating arrangement in accordance with an example embodiment of the disclosed concept;

FIG. 2 is a detail view of a portion of the arrangement of FIG. 1 as indicated in FIG. 1;

FIG. 3 is an exploded perspective view of the arrangement of FIG. 1;

FIG. 4 is another exploded perspective view of the arrangement of FIG. 1;

FIG. 5 is a partially schematic partially sectional view of another example arrangement for use in a decorator machine in accordance with another example embodiment of the disclosed concept;

FIG. 6 is a detail view of a portion of the arrangement of FIG. 5 as indicated in FIG. 5;

FIG. 7 is an exploded perspective view of the arrangement of FIG. 5;

FIG. 8 is another exploded perspective view of the arrangement of FIG. 5;

FIG. 9 is a partially schematic partially sectional view of another example arrangement for use in a decorator machine in accordance with another example embodiment of the disclosed concept;

FIG. 10 is a detail view of a portion of the arrangement of FIG. 9 as indicated in FIG. 9;

FIG. 11 is an exploded perspective view of the arrangement of FIG. 9;

FIG. 12 is another exploded perspective view of the arrangement of FIG. 9;

FIG. 13 is a partially schematic partially sectional view of another example arrangement for use in a decorator machine in accordance with another example embodiment of the disclosed concept;

FIG. 14 is a detail view of a portion of the arrangement of FIG. 13 as indicated in FIG. 13;

FIG. 15 is a partially exploded perspective view of the arrangement of FIG. 13;

FIG. 16 is a partially schematic partially sectional view of another example arrangement for use in a decorator machine in accordance with another example embodiment of the disclosed concept;

FIG. 17 is a detail view of a portion of the arrangement of FIG. 16 as indicated in FIG. 16; and

FIG. 18 is a partially exploded perspective view of the arrangement of FIG. 16.

### DETAILED DESCRIPTION OF THE INVENTION

It is to be appreciated that the specific elements and embodiments illustrated in the figures herein and described in the following specification are simply exemplary embodiments of the disclosed concept, which are provided as non-limiting examples solely for the purpose of illustration. Therefore, specific dimensions, orientations, assembly, number of components used, embodiment configurations and other physical characteristics related to the embodiments disclosed herein are not to be considered limiting on the scope of the disclosed concept.

Directional phrases used herein, such as, for example, clockwise, counterclockwise, left, right, top, bottom, upwards, downwards and derivatives thereof, relate to the orientation of the elements shown in the drawings and are not limiting upon the claims unless expressly recited therein.

As used herein, the singular form of “a”, “an”, and “the” include plural references unless the context clearly dictates otherwise.

As used herein, “structured to [verb]” means that the identified element or assembly has a structure that is shaped, sized, disposed, coupled and/or configured to perform the identified verb. For example, a member that is “structured to move” is movably coupled to another element and includes elements that cause the member to move or the member is otherwise configured to move in response to other elements or assemblies. As such, as used herein, “structured to [verb]” recites structure and not function. Further, as used herein, “structured to [verb]” means that the identified element or assembly is intended to, and is designed to, perform the identified verb. Thus, an element that is merely capable of performing the identified verb but which is not intended to, and is not designed to, perform the identified verb is not “structured to [verb].”

As employed herein, the term “number” shall mean one or an integer greater than one (i.e., a plurality).

Embodiments of the disclosed concept utilize passageways (porting) manufactured into decorator shafting to supply pneumatic air for selectively actuating the pneumatic plate cylinders and rolls on the printing side. Such arrangements also employ one or more valves to control whether air supply is active to a particular shaft, as well as one or more sensors to ensure that pressurized air is not present at the cylinders/rolls when a decorator machine start sequence is initiated.

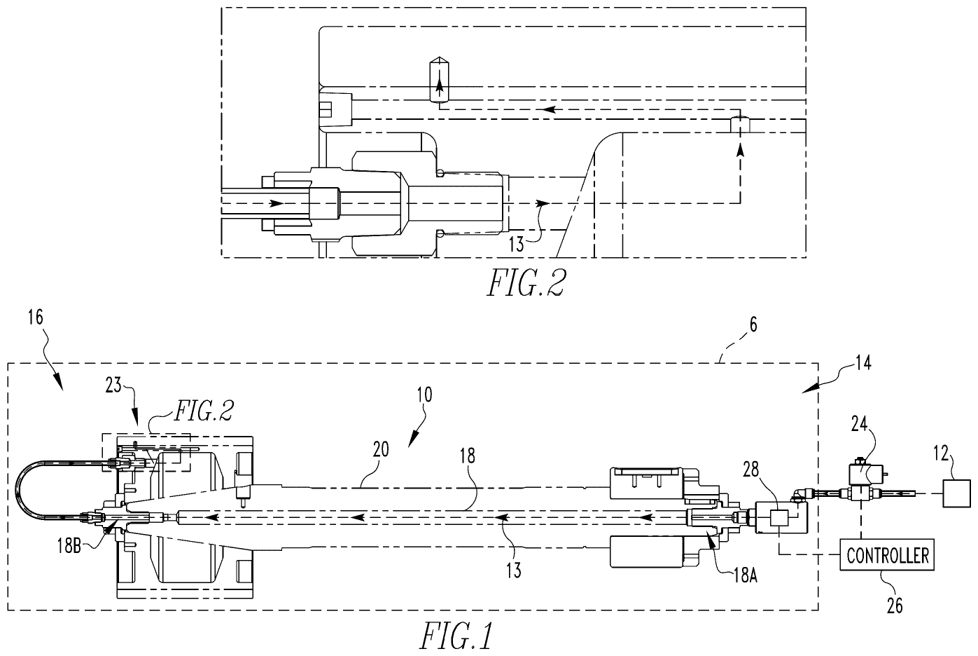

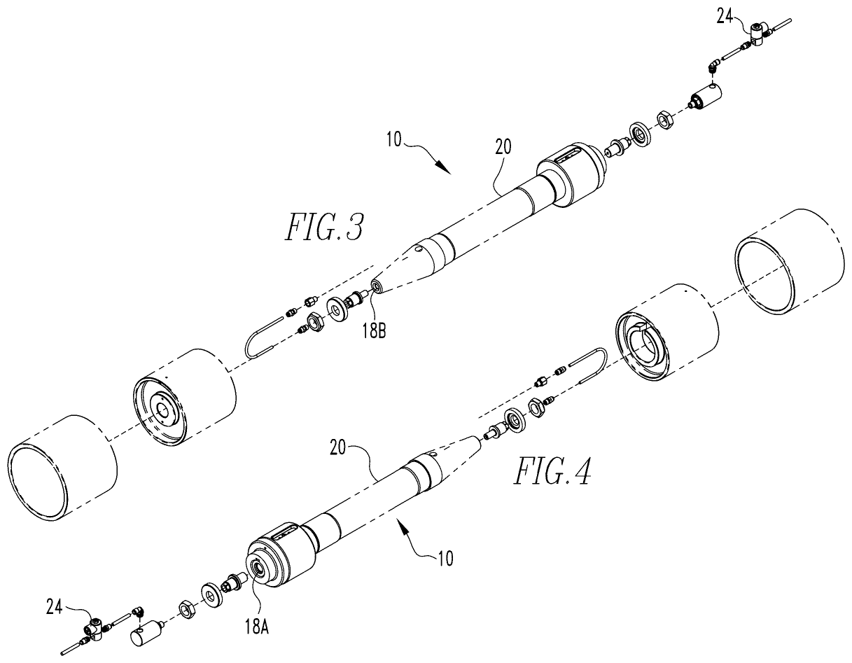

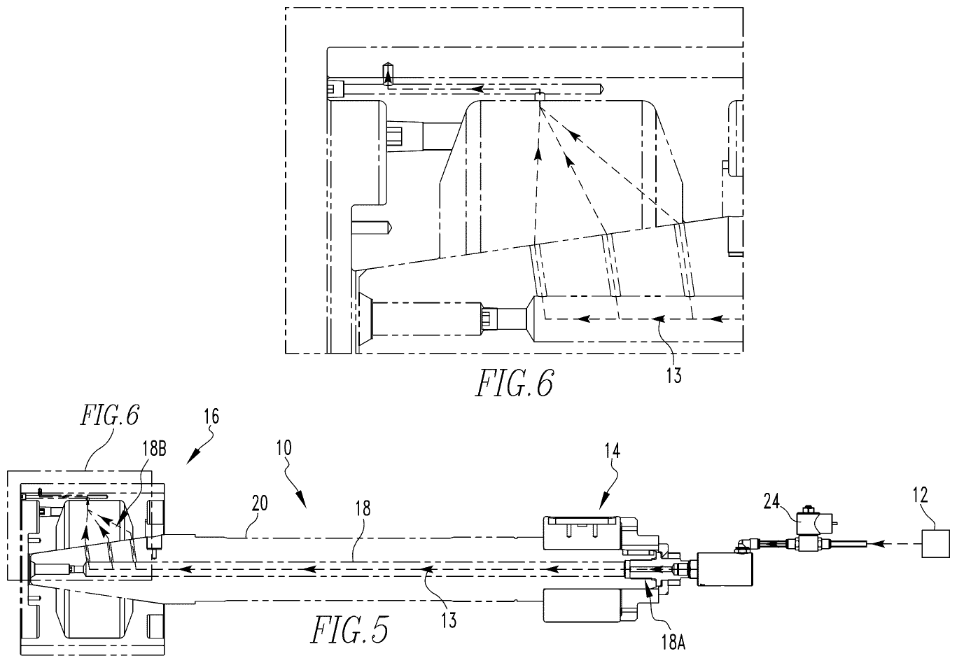

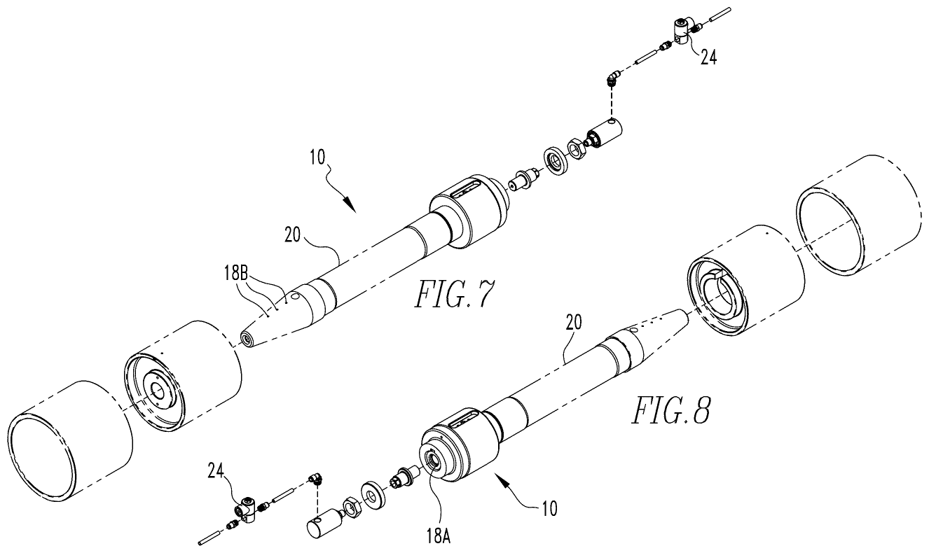

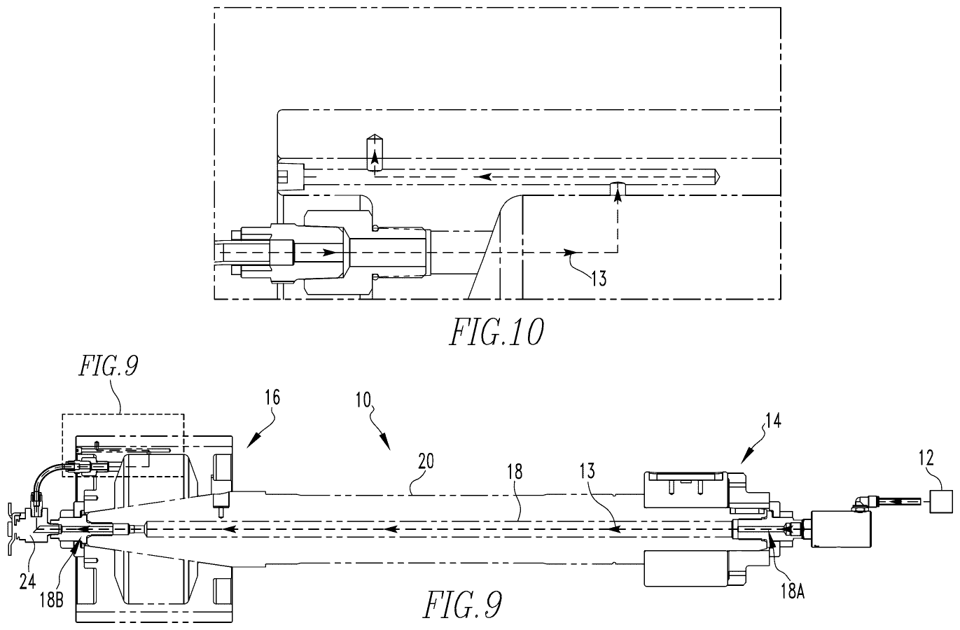

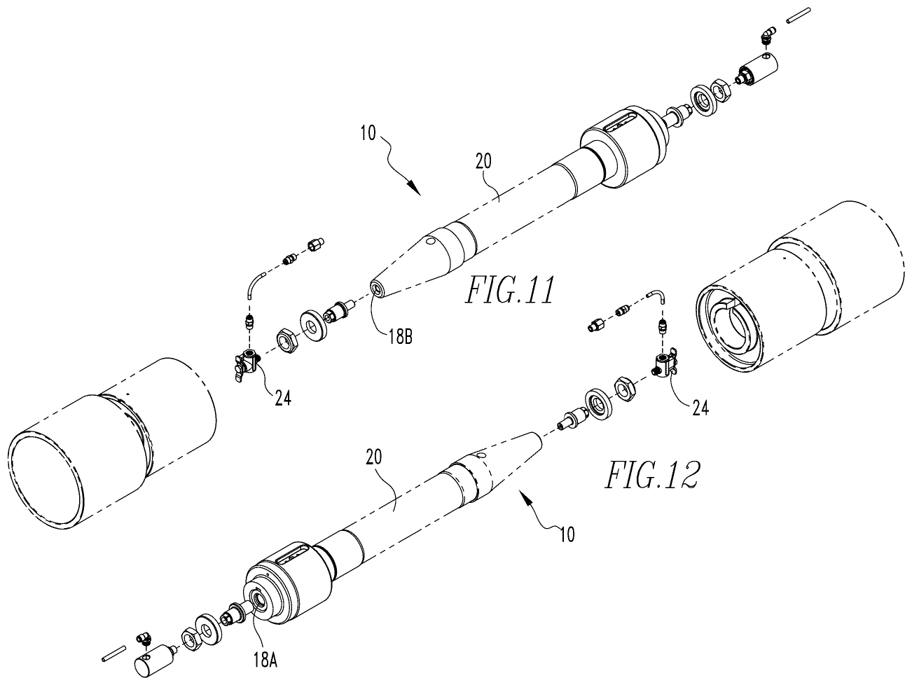

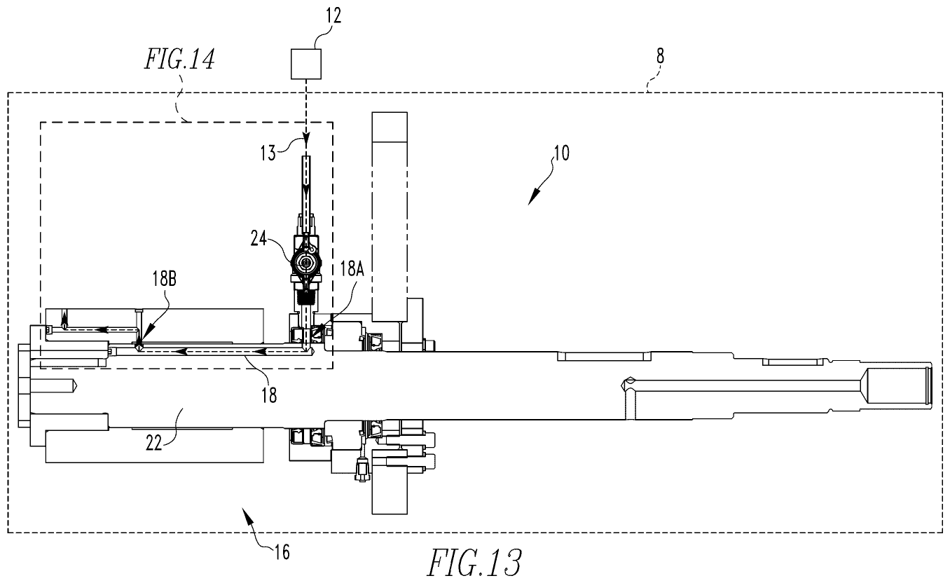

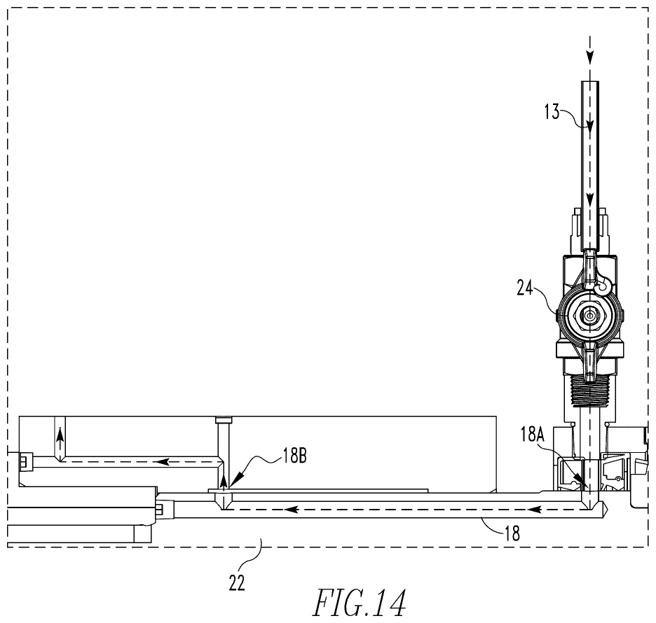

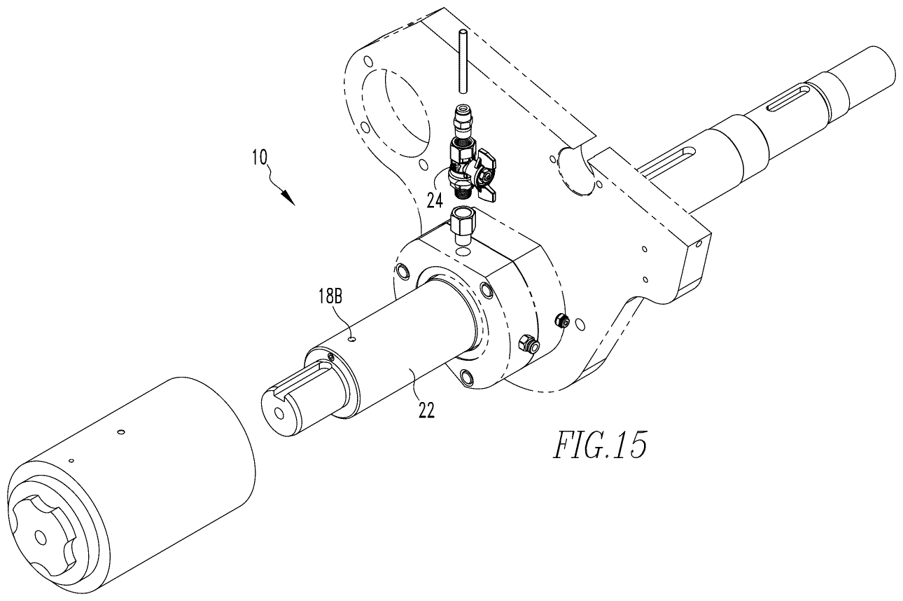

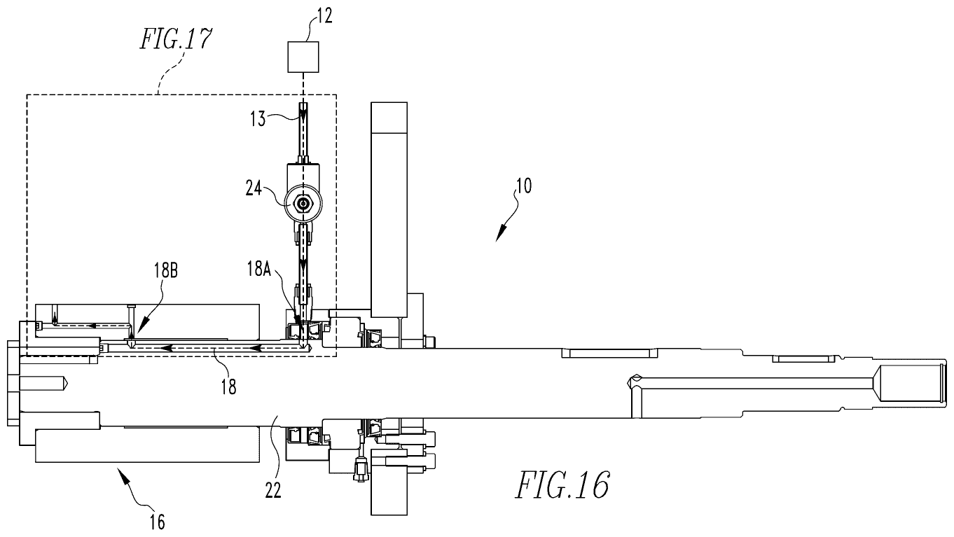

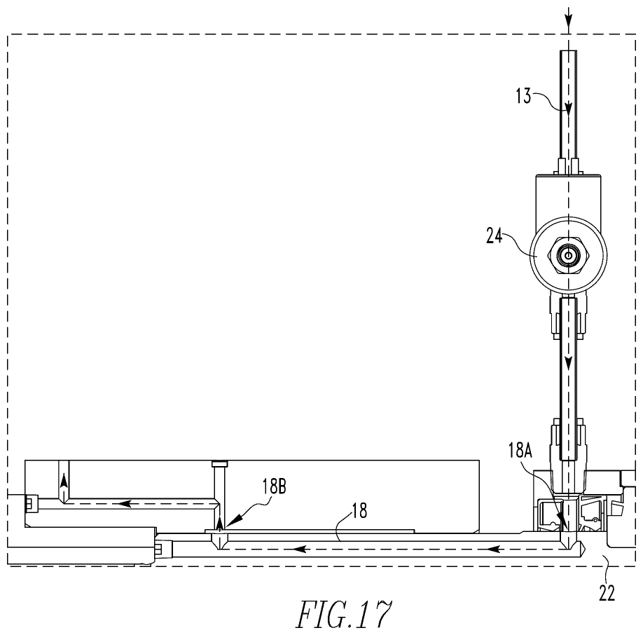

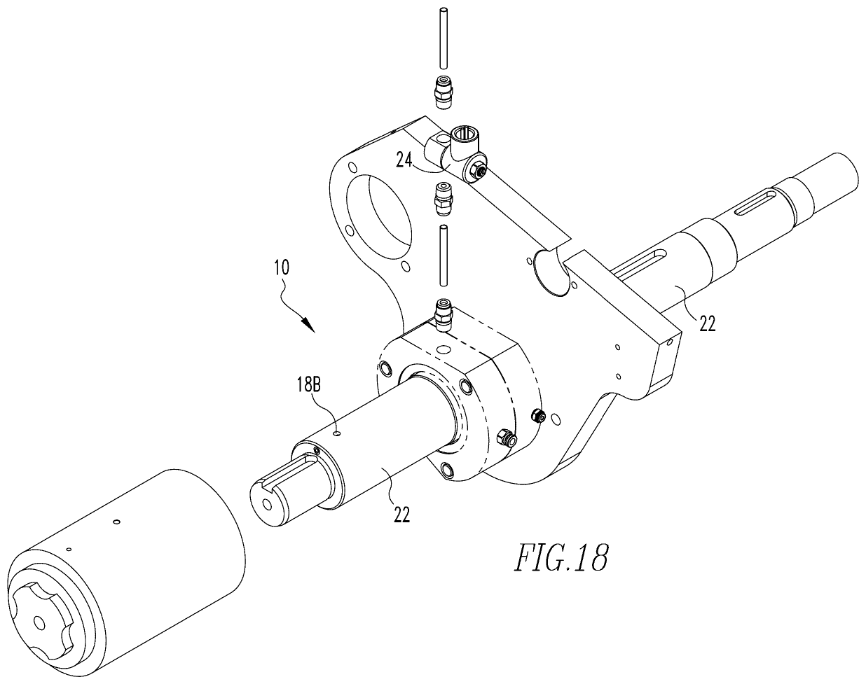

FIGS. 1-12 show example arrangements 10 in accordance with example embodiments of the disclosed concept for use in a Stolle Concord Decorator machine 6 (shown schematically in FIG. 1) and FIGS. 13-18 show example arrangements in accordance with example embodiments of the disclosed concept for use in a Stolle Rutherford Decorator machine 8 (shown schematically in FIG. 13). It is to be appreciated that such examples are provided for exemplary purposes only and that the disclosed concept is not limited to applications related only to such decorator machines 6, 8, but instead the concepts disclosed herein may be readily applied to other can decorator machines without varying form the scope of the disclosed concept. In each of the example arrangements 10 illustrated herein, pneumatic air from a pressurized air source 12 (shown schematically, e.g., an air compressor or other suitable arrangement) is communicated (as shown by arrows 13) generally to a printing side 16 of the arrangement 10 via a number of passageways 18 defined in a rotatable shaft 20 (FIGS. 1-12), 22 (FIGS. 13-18) of the decorator machine 6, 8. More particularly, each passageway 18 conveys a supply of pressurized air from a number of inlets 18A in the rotatable shaft 20, 22 that is in communication with, and structured to receive a supply of pressurized gas from the pressurized air source 12 to a number of outlets 18B in the rotatable shaft 20, 22 that is/are in communication with a plate cylinder 23 of the decorator machine 6, 8.

Passageway(s) 18 may be created/formed in shaft 20 or repurposed from passageways intended for other use. For example, Concord decorator cylinder shafts (e.g., such as shaft 20 shown in FIGS. 1-12) are almost always sold with coolant porting through the center. Such coolant porting is often not used by can production plants and thus may be repurposed in accordance with the disclosed concept for supplying air from the drive side 14 of the decorator machine through to the printing side 16 of the decorator machine. Rework of the shafts 20 can be done in-situ on the machine with minimal effort by drilling through the short center portion of the shaft end and installing fittings/supply lines to feed the cylinder/roll. Additionally, since the Concord plate cylinder is so large, rather than port air out through the end of the shaft, a cross drill may be placed radially through the taper on the end of the Concord shaft to allow air to be supplied to the cylinder from the inside of the cylinder itself (e.g., such as shown in the example embodiment of FIGS. 5-8). Rutherford decorator cylinder shafts 22 are commonly sold in several configurations which may or may not make use of center porting to provide functionality to other aspects of the machine 8. In this case, air may be ported into the shaft 22 eccentrically and fed from a tandem seal near the center plate of the Rutherford ink station.

Actuation of the air supply to the pneumatic cylinders/rolls of the printing side 16 is critical to ensure the locking functionality of the cylinder. This is accomplished by use of either a manual or solenoid valve 24 placed between the source 12 of pressurized gas and components on printing side 16. One example placement of the valve 24 is within the operator's reach on each station that contains a pneumatically actuated cylinder/roll, but in the case of a solenoid valve, the valve 24 may be actuated electronically by a controller 26 provided as an element of the control system of the decorator or as an element remote to the decorator machine 6, 8 in communication with the valve 24.

Embodiments of the disclosed concept incorporate a means of ensuring pressurized air is not supplied to the cylinders/rolls of the printing side 16 when a machine start sequence is initiated. This is accomplished by placing a number of sensors 28 (FIG. 1) positioned and structured to detect pressure or flow or both on each air line that feeds the cylinders/rolls in communication with the controller 26. This way, in the case of a manually actuated air valve, if an operator fails to close the valve and lock the pneumatic cylinder/roll onto the shaft, the machine will still not enter an unsafe condition because the machine control algorithm will not allow the machine to start while pressure/flow are active to the cylinder/roll.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

In the claims, any reference signs placed between parentheses shall not be construed as limiting the claim. The word “comprising” or “including” does not exclude the presence of elements or steps other than those listed in a claim. In any device claim enumerating several means, several of these means may be embodied by one and the same item of hardware. The word “a” or “an” preceding an element does not exclude the presence of a plurality of such elements. The mere fact that certain elements are recited in mutually different dependent claims does not indicate that these elements cannot be used in combination.

What is claimed is:

1. An arrangement for communicating a supply of pressurized gas to a plate cylinder of a decorator machine, the arrangement comprising:
a rotatable shaft structured to be disposed and rotated within the decorator machine;
a number of passageways defined in the rotatable shaft, each passageway of the number of passageways having an inlet structured to receive the supply of pressurized gas and an outlet structured to convey the supply of pressurized gas to the plate cylinder.

2. The arrangement of claim 1, further comprising a valve in communication with the number of passageways and structured to selectively control the supply of pressurized gas to the plate cylinder.

3. The arrangement of claim 2, wherein the valve is disposed and configured to selectively control the supply of pressurized gas to the plate cylinder by selectively controlling the supply of pressurized gas to the number of passageways.

4. The arrangement of claim 2, wherein the valve is disposed and configured to selectively control the supply of pressurized gas to the plate cylinder by selectively controlling the supply of pressurized gas from the number of passageways to the plate cylinder.

5. The arrangement of claim 2, wherein the valve comprises a manual valve.

6. The arrangement of claim 2, wherein the valve comprises a solenoid valve.

7. The arrangement of claim 6, further comprising a controller in communication with the solenoid valve, the controller being structured to selectively control operation of the solenoid valve.

8. The arrangement of claim 5, further comprising:
a number of sensors, each sensor of the number of sensors being structured to detect a pressure and/or a flow of the supply of pressurized gas to the plate cylinder; and
a controller in communication with the number of sensors, the controller structured to control operation of the decorator machine based on the pressure and/or the flow detected by the number of sensors.

9. The arrangement of claim 1, further comprising a pressurized air source structured to produce the supply of pressurized gas.

10. The arrangement of claim 9, wherein the pressurized air source comprises an air compressor.

11. A decorator machine comprising:
a plate cylinder; and
an arrangement for communicating a supply of pressurized gas to the plate cylinder, the arrangement comprising:
a rotatable shaft disposed and selectively rotatable within the decorator machine; and
a number of passageways defined in the rotatable shaft, each passageway of the number of passageways having an inlet structured to receive the supply of pressurized gas and an outlet structured to convey the supply of pressurized gas to the plate cylinder.

12. The decorator machine of claim 11, further comprising a valve in communication with the number of passageways and structured to selectively control the supply of pressurized gas to the plate cylinder.

13. The decorator machine of claim 12, wherein the valve is disposed and configured to selectively control the supply of pressurized gas to the plate cylinder by selectively controlling the supply of pressurized gas to the number of passageways.

14. The decorator machine of claim 12, wherein the valve is disposed and configured to selectively control the supply of pressurized gas to the plate cylinder by selectively controlling the supply of pressurized gas from the number of passageways to the plate cylinder.

15. The decorator machine of claim 12, wherein the valve comprises a manual valve.

16. The decorator machine of claim 12, wherein the valve comprises a solenoid valve.

17. The decorator machine of claim 16, further comprising a controller in communication with the solenoid valve, the controller being structured to selectively control operation of the solenoid valve.

18. The decorator machine of claim 15, further comprising:
a number of sensors, each sensor of the number of sensors being structured to detect a pressure and/or a flow of the supply of pressurized gas to the plate cylinder; and
a controller in communication with the number of sensors, the controller structured to control operation of the decorator machine based on the pressure and/or the flow detected by the number of sensors.

19. The decorator machine of claim 11, further comprising a pressurized air source structured to produce the supply of pressurized gas.

20. The decorator machine of claim 19, wherein the pressurized air source comprises an air compressor.
